(19) United States
(12) Patent Application Publication
(10) Pub. No.: US 2012/0198234 A1
(43) Pub. Date: Aug. 2, 2012

(54) METHOD AND APPARATUS FOR ENSURING THE INTEGRITY OF A DOWNLOADED DATA SET

(75) Inventors: Christopher C. Chung, Fremont, CA (US); Michael J. Seilnacht, Fremont, CA (US); Thomas J. Holodnik, Cupertino, CA (US)

(73) Assignee: INTUIT INC., Mountain View, CA (US)

(21) Appl. No.: 13/017,783

(22) Filed: Jan. 31, 2011

(51) Int. Cl. H04L 9/32

(52) U.S. Cl. 713/171; 713/176

(57) ABSTRACT

The disclosed embodiments provide a system that ensures the integrity of a downloaded data set. During operation, a browser application executing on a computing device receives a data set that was signed using the private key of a host computer. The browser application stores this signed data set in a browser data store. Subsequently, the browser application also receives a public key from the host computer (e.g., while accessing a web page associated with the signed data set). The browser application ensures the integrity of the data set by executing scripted program code that: uses the public key to decode the signature for the data set; calculates a hash value for the signed data set; and compares the decoded signature with the hash value to validate the data set.

### BACKGROUND

1. Field of the Invention

This disclosure generally relates to techniques for ensuring the integrity of data downloaded by a browser application. More specifically, this disclosure relates to techniques for validating signed data that has been stored in a data store that is associated with an Internet browser.

2. Related Art

Easy access to computing devices and plentiful network bandwidth have made it very easy to share information and applications. For instance, Internet browsers allow users to easily download and execute web-based applications on a range of devices, including desktop computers and portable computing devices such as tablets and smartphones. Such browsers leverage a set of underlying standards to provide platform-independent interfaces and enable a wide range of application capabilities. For example, the HyperText Markup Language (HTML) provides a standardized underlying language that facilitates designing web pages that can be displayed in a range of browsers.

Recent changes to the HTML standard seek to improve application performance by introducing the notion of offline (“local”) browser-side storage. Storing data needed by browser-based applications on a local computing device can improve performance (e.g., by reducing delays associated with having to re-download data). However, such capabilities can also lead to potential data integrity issues. For instance, such data may be subject to tampering by the operating system, by the browser, or by other browser-based applications that make use of such local storage. Moreover, sending stored data back to an originating server for integrity checking is often impractical. Hence, what is needed are techniques for ensuring the integrity of data stored in such browser-side storage without the above-described problems.

### SUMMARY

The disclosed embodiments provide a system that ensures the integrity of a downloaded data set. During operation, a browser application executing on a computing device receives a data set that was signed using the private key of a host computer. The browser application stores this signed data set in a browser data storage mechanism (or “data store”). The browser application also receives a public key from the host computer (e.g., while accessing a web page associated with the signed data set). The browser application can ensure the integrity of the data set by executing scripted program code that: uses the public key to decode the signature for the data set; calculates a hash value for the signed data set; and compares the decoded signature with the hash value to validate the data set. Validating the data set ensures that the data set has not been modified while it was stored in the browser data store, and can reduce browser application delays associated with re-downloading the data set.

In some embodiments, the browser application forwards the signed data set to another computing device. This target computing device then validates the data set using the public key. In this embodiment, transferring the signed data set to the target computing device via the browser application facilitates preserving data integrity for the data set without requiring direct communication between the host computer and the target computing device.

In some embodiments, the browser application only caches the public key for a limited lifespan. If necessary, the browser application can re-acquire the public key after expiration (e.g., by re-accessing a web page associated with the data set).

In some embodiments, the host computer signs the data set using an asymmetric signing technique. In alternative embodiments, the host computer may also use a hash-based message authentication code (HMAC).

In some embodiments, the host computer generates the signature for the data set based on one or more of the following: a data block; an identifier associated with the data block; size data for the data block; a nonce; a timestamp; and/or a user identifier.

In some embodiments, the data store provides domain-independent storage capabilities that can be accessed using browser-based scripting languages, language interpreters, and markup languages.

### BRIEF DESCRIPTION OF THE FIGURES

FIG. 1 illustrates an exemplary system where a client computing device validates data stored in a browser data store to ensure the integrity of a downloaded data set in accordance with an embodiment.

FIG. 2 presents a flow chart that illustrates the process of ensuring the integrity of a downloaded data set in accordance with an embodiment.

FIG. 3 illustrates an exemplary alternative system where a client computing device forwards signed data to another computing device in accordance with an embodiment.

FIG. 4 illustrates a computing environment in accordance with an embodiment.

FIG. 5 illustrates a computing device in accordance with an embodiment.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a non-transitory computer-readable storage medium, which may be any device or non-transitory medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, a full-custom implementation as part of an integrated circuit (or another type of hardware implementation on an integrated circuit), field-programmable gate arrays (FPGAs), a dedicated or shared processor that executes a particular software module or a piece of code at a particular time, and/or other programmable-logic devices now known or later developed. When the hardware modules are activated, the hardware modules perform the methods and processes included within the hardware modules.

### Browser-Side Web Storage

Recent changes to the HTML standard (e.g., the HTML 5 specification) introduce offline storage capabilities (sometimes referred to as “Web Storage” or “DOM Storage”) for Internet browsers (also referred to simply as “browsers”). Data stored in such client-side storage mechanisms may be accessed by browser applications (e.g., applications comprised of scripted program code that execute in a browser) via a range of client-side scripting APIs (e.g., JavaScript™ APIs; JavaScript is a trademark of Oracle Corporation) or from browser runtime environments (such as Silverlight™ or Adobe Flash™; Silverlight is a trademark of the Microsoft Corporation, Adobe Flash is a trademark of the Adobe Corporation), but cannot be accessed directly from a hosting web server. The scope and lifetime of such data may vary depending on the browser application and configuration. For instance, stored data may be configured to be only available to a specific web page, to all scripts originating from a domain, or to any script originating from any domain. Furthermore, the stored data may be configured to persist only for a given browser application session, for the life of a browser application window (e.g., for the lifetime of a browser tab), or until a browser is closed. Note that Web Storage is distinct from browser cookies, which are typically associated with individual pages and directly manipulated by the server and the browser.

Storing data needed by browser-based applications on a local computing device can substantially improve the performance of browser-based applications that operate upon an aggregated set of data. For instance, Web Storage may be used to store a log of account transactions or invoices (for a financial application) or lists of previous emails (for a web-based email application). Storing application data locally reduces the delays associated with having to re-download data, thereby typically improving application response time and the application user's experience. However, because a server hosting a web-based application generally cannot trust the client (browser) side, such storage capabilities also raise potential data integrity issues. For instance, such data may be subject to tampering from: the operating system; software running on the operating system; the browser; browser plugins; web pages that load and run scripted code from third-party websites (e.g., HTML pages that load scripted code from other websites and execute within the context of the page from the originating domain); and/or other browser-based applications that make use of Web Storage. Hence, before executing a transaction based on such stored data, a web-based application needs to ensure with high confidence that the data stored on the client side is still “good” (e.g., intact and unmodified).

Unfortunately, currently available browsers do not provide any standard way to ensure data integrity. Moreover, sending a potentially large amount of stored data back to an originating server for integrity checking eliminates many of the benefits of storing such data on the client side, especially if the client computing device has an asymmetric network connection.

Embodiments of the present invention provide techniques for validating data stored in a client-side browser data store to ensure the integrity of a downloaded data set.

### Tamper-Proofing Data Stored in Client-Side Web Storage

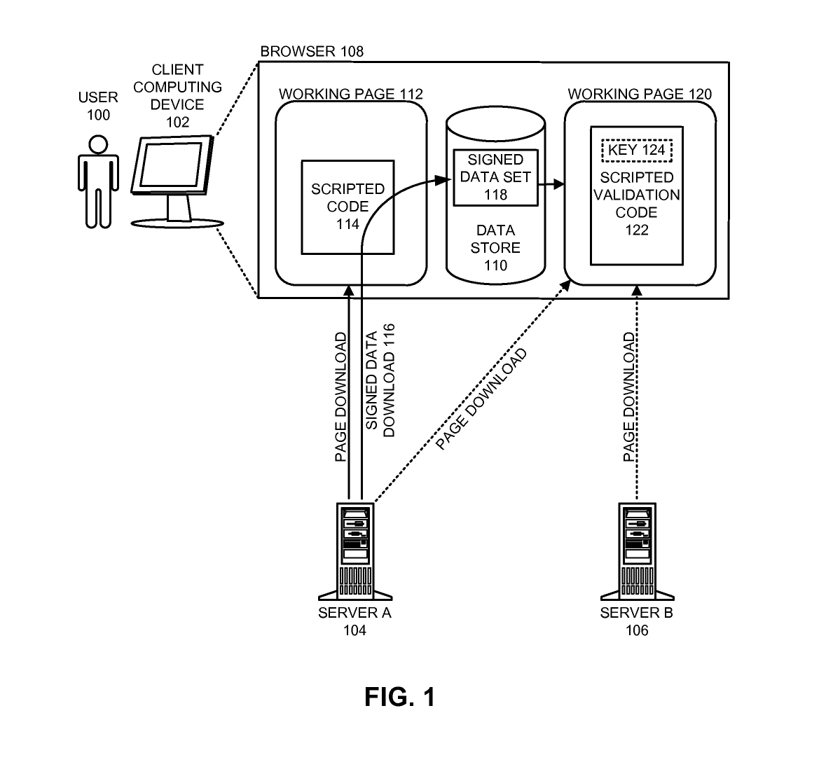

FIG. 1 illustrates an exemplary system where a client computing device 102 validates data stored in a browser data store 110 to ensure the integrity of a downloaded data set. Browser 108 supports Web Storage, in the form of data store 110. A user 100 uses browser 108 to access server A 104, resulting in the download of working page 112. Working page 112 includes scripted code 114 (e.g., embedded JavaScript™ program code) that downloads 116 a signed data set 118 from Server A 104. Scripted code 114 stores signed data set 118, which was signed by server A 104 using a private asymmetric encryption key, into data store 110. For instance, depending on the organization of data store 110, scripted code 114 may store signed data set 118 as separate pieces of data in data store 110 (e.g., as (1) a set of actual application data (referred to as “target data”) and (2) an associated signature).

At some point subsequent to storing signed data set 118, user 100 may access another web page containing scripted code that attempts to access signed data set 118. For instance, user 100 may download another working page 120 (which may be the same as working page 112) from server A 104 or server B 106. Working page 120 includes scripted validation code 122 and a public asymmetric encryption key 124 that is associated with the private encryption key that server A 104 used to sign signed data set 118; note that public key 124 may be embedded in scripted validation code 122, directly in working page 120, or in a range of other locations. While executing scripted validation code 122, the system: retrieves the target data and its associated signature from data store 110; calculates a hash value for the target data; uses public key 124 to decode the signature (e.g., thereby retrieving an original hash value computed by server A 104); and confirms that the decoded signature matches the hash value for the target data. If public key 124, the target data, or the target data's signature have been modified, this validation check fails. Note that there are many possible techniques for computing hash values, and that the described embodiments of the present invention are independent of any specific hash technique as long as the chosen hash technique has sufficiently high entropy. Note also that the signed data may be structured in many different ways (e.g., in a “raw” form, such as XML or binary, in a JavaScript™ Object Notation (JSON) format, in a section of scripted code, etc.).

Note that the described checks can all be performed on the client side without querying the originating server A 104 for verification—signed data set 118 and public key 124 are provided by the server, but all computation associated with the check operation occurs on client computing device 102, thus reducing server load. Local data that has been successfully validated does not need to be re-downloaded. In some embodiments, data retrieved by one browser can be stored, transferred to another browser instance, and then successfully verified (e.g., in a backup and restore context). Note that stored data may not be completely up-to-date (e.g., may not include more recent user data that has been created and stored on the server after the original download to the client; determining the staleness of data may be the server's and/or application's responsibility, and is independent of the described techniques), but is confirmed to match the original data that was previously sent by the server and stored locally. Note also that the described techniques are intended for read-only data, not modifiable data. Stored data that is modified by a browser application may need to be sent back to a server to be checked, signed, and then sent back to the client computing device 102.

In some embodiments, a server may use a range of asymmetric digital signing techniques (e.g., DSA, RSA, etc.) and input fields to generate a signature value. For instance, when generating a signature, a server may first calculate a cryptographic hash digest that uniquely identifies the data being signed, and then use a private key to encrypt this hash value into the signature value. For example, the cryptographic hash operation may calculate the hash digest value based on a number of fields that include (but are not limited to): (1) the target data (to be validated); (2) a timestamp value; (3) a cryptographic nonce (e.g., a one-time random value); (4) a size field; and/or (5) a user identifier. Adding additional fields into the hash digest ensures that the hash digest value is unique; adding a nonce helps to thwart replay and substitution attacks, while including a timestamp helps: (1) make the hash digest unique; (2) overcome time clock synchronization issues; and (3) facilitate timing out older versions of stored target data.

Performing numerous asymmetric signature operations can affect server and client performance. Signing a (more compact) hashed digest value instead somewhat reduces the computational overhead associated with signatures (in comparison with encrypting the entire target data block being sent). In some embodiments, the system may also tune the size of the data set being signed to further reduce such overhead. For instance, the system may sign data at a coarse granularity, so that each signature value is associated with a large set of results and the number of signing and validating operations is reduced (e.g., for a banking application, all of the transactions for an entire month may be associated with a single signature value). Alternatively, the system may instead sign data at a finer granularity (e.g., signing each individual transaction or data item separately). The system may consider a range of factors in such granularity decisions, including: application and data use characteristics; performance impacts; and client, server, and network capabilities. Note that in some embodiments the system may also use multiple key pairs to ensure data integrity (e.g., using different key pairs for different data sets or portions of a data set, different client computing devices, and/or different users; in some implementations, scripted code may access keys and/or certificates from a list of certificate authorities maintained by a browser). Note also that changing a key pair during operation may involve flushing signed data stored in the browser data store.

When validating the stored data on the client side, the browser application: (1) uses the received public key to decrypt the signature, thereby determining the hash digest; (2) uses the same cryptographic hash technique used by the server to calculate a local hash digest for the locally stored data; and then (3) compares the (decrypted) hash digest with the locally computed hash digest to confirm that the stored data fields have not been modified. Note that the public key acts as a session key; the validation code can only confirm the validity of the signed data when the needed public key is available. In some embodiments, the browser application or data store may be configured to discard or otherwise invalidate the public key (e.g., after a specified time interval or when a user navigates away from a browser application's web page). Alternatively, the client system may be configured to cache the public key for a longer time interval (e.g., either in conjunction with or separately from the caching of the page that includes the public key), or when a client computing device goes offline (e.g., to allow the application to continue to be used despite the loss of a network connection). The system may also need to configure the lifespan and/or caching policies for other elements (such as scripted code and items in the data store) to optimize the performance and/or offline capabilities of a browser application. In some embodiments, a web page providing a browser application may include a set of suggested parameters for the client data store.

Note that, while the above-described techniques enable browser applications to confirm that their stored data has not been modified, they do not prevent signed data stored in Web Storage from being read by other scripted applications executing in a browser. For instance, scripted code in pages downloaded from a first domain may import and run scripted code from additional, different domains that also accesses stored data. Furthermore, different browser implementations may provide different security policies and rules, and may have different vulnerabilities (and bugs). The described techniques extend Web Storage to provide an abstraction of a persistent write-through browser storage cache on the client side whose elements are signed to indicate authenticity. In some embodiments, the target data may also be fully encrypted to provide additional data privacy.

Note also that the described techniques may be used to protect and store scripted code. For instance, large browser applications may include large sets of complex scripted code. For example, browser-based document editing tools or map applications may include structures such as large lookup tables or templates that are used to create and compile scripted code at runtime. Re-downloading such code may involve substantial time and effort, especially for a mobile computing device with a limited network connection and/or computing capabilities. Executing scripted code stored on the client side is typically very risky, because the client often cannot be trusted, and such stored code may be modified by other parties. However, if the scripted code has been signed using the described techniques, the system can perform the check to confirm that the stored code is intact, and if so, proceed to execute it. In some embodiments, a number of different scripted code elements in a downloaded page (e.g., in a large “mashup” application) that have been signed separately using different vendors' private keys may be validated while executing a browser application comprised of many such code elements.

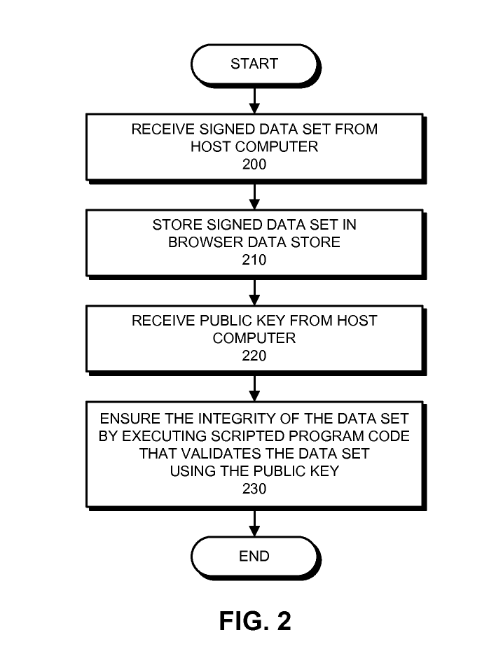

FIG. 2 presents a flow chart that illustrates the process of ensuring the integrity of a downloaded data set. During operation, a browser application executing on a computing device receives a data set that was signed using the private key of a host computer (operation 200). The browser application stores this signed data set in a browser data store (operation 210). Subsequently, the browser application also receives a public key from the host computer (e.g., while accessing a web page associated with the signed data set) (operation 220). The browser application then ensures the integrity of the data set by executing scripted program code that validates the data set using the public key (operation 230). For instance, the scripted program code may: use the public key to decode the signature for the data set; calculate a hash value for the signed data set; and compare the decoded signature with the hash value to validate the data set. Validating the data set ensures that the data set has not been modified while it was stored in the browser data store. Note that in some embodiments the public key may also be received from the host computer at the same time as the signed data set (or even before the signed data set is received from the host computer).

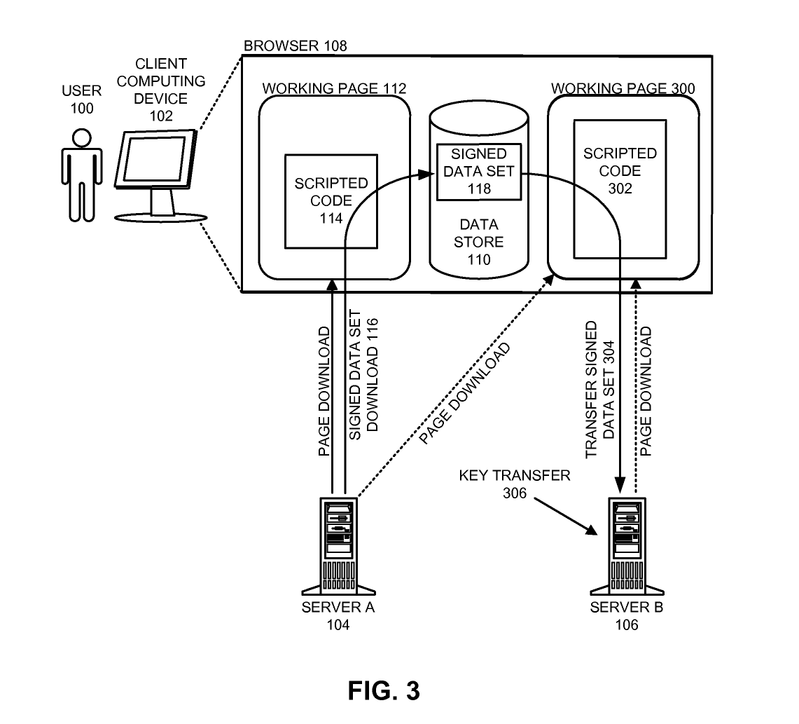

FIG. 3 illustrates an exemplary alternative system where the client computing device 102 does not validate the data stored by browser 108 (as in FIG. 1), but instead forwards it to another computing device, server B 106. For instance, while signed data set 118 may be loaded into data store 110 as described for FIG. 1, working page 300 may include scripted code 302 that does not validate signed data set 118, but instead transfers 304 a copy of signed data set 118 to server B 106 (e.g., in a post request). Server B 106 can then validate the received data using the associated public key (which it may receive from browser 108 during transfer 304 or via another trusted key transfer operation 306). In some embodiments scripted code 302 may also validate signed data set 118 prior to forwarding the data to server B 106 (e.g., to ensure the integrity of the data before incurring time and network bandwidth in forwarding the data to server B 106). Note that some special arrangements (e.g., special tags, setup, and/or scripted code) may be needed to pass data received from server A 104 to server B 106 if the two servers are in different Internet domains.

The described forwarding techniques enable a range of potential interactions and benefits. For instance, a browser application may pass signed data (e.g., signed state elements and/or document objects) on to another server as credentials, or to inform the receiving server of a decision. Such an arrangement allows the receiving server (e.g., server B 106 in FIG. 3) to be more loosely associated with the original host server than might otherwise be possible. For example, such data forwarding capabilities may allow two (or more) servers to be configured in a loosely coupled federation, where one server is optimized to distribute signed data, and another is optimized to receive (from a browser application), validate, and act upon such data. In such arrangements, the stored data cache in the browser's data store may serve as a “single sign-on token.” This arrangement may be more practical than other approaches that involve a tight communication link between the two servers, especially if the data needs to be downloaded to and/or approved of on the client device anyway. More specifically, such embodiments allow the receiving server to ensure that the received data has integrity, while potentially reducing the direct transfers needed between the two servers to key transfers. In such embodiments, the reduced load for the host server (which no longer needs to transfer data directly to the receiving server) may come at the cost of additional validation operations on the receiving server.

In summary, embodiments of the present invention involve validating data stored in a client-side browser store to ensure the integrity of a downloaded data set. Such validation capabilities provide the assurance that the locally stored data has not been modified by hostile parties that are trying to harm a browser application, thereby allowing local browser storage (e.g., Web Storage) to be used in a safe manner and improving the performance of browser applications.

### Computing Environment

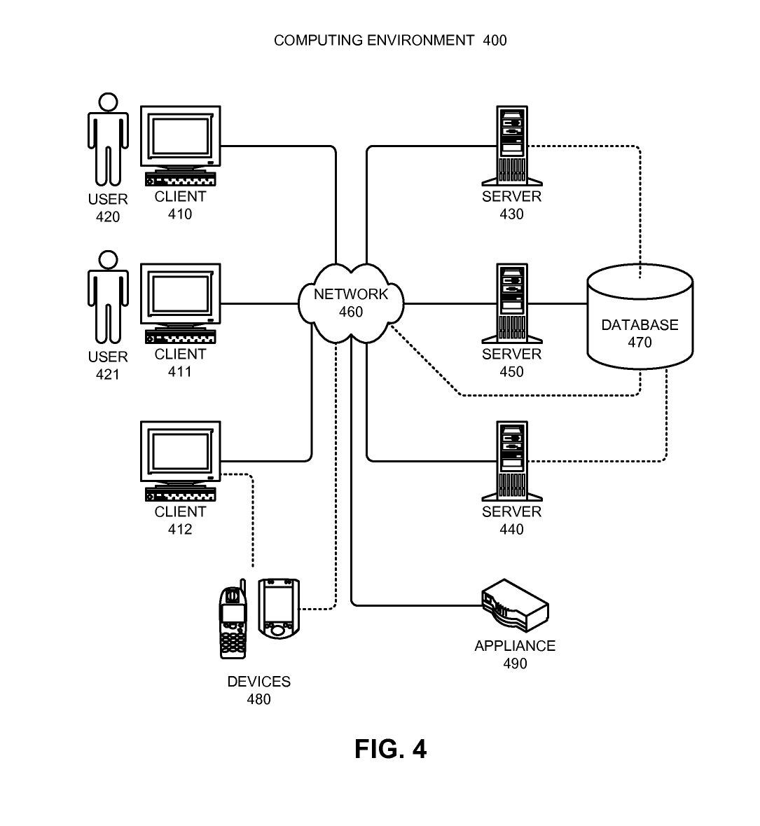

In some embodiments of the present invention, techniques for ensuring the integrity of downloaded data sets can be incorporated into a wide range of computing devices in a computing environment. For example, FIG. 4 illustrates a computing environment 400 in accordance with an embodiment of the present invention. Computing environment 400 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 4, computing environment 400 includes clients 410-412, users 420 and 421, servers 430-450, network 460, database 470, devices 480, and appliance 490.

Clients 410-412 can include any node on a network that includes computational capability and includes a mechanism for communicating across the network. Additionally, clients 410-412 may comprise a tier in an n-tier application architecture, wherein clients 410-412 perform as servers (servicing requests from lower tiers or users), and wherein clients 410-412 perform as clients (forwarding the requests to a higher tier).

Similarly, servers 430-450 can generally include any node on a network including a mechanism for servicing requests from a client for computational and/or data storage resources. Servers 430-450 can participate in an advanced computing cluster, or can act as stand-alone servers. For instance, computing environment 400 can include a large number of compute nodes that are organized into a computing cluster and/or server farm. In one embodiment of the present invention, server 440 is an online “hot spare” of server 450.

Users 420 and 421 can include: an individual; a group of individuals; an organization; a group of organizations; a computing system; a group of computing systems; or any other entity that can interact with computing environment 400.

Network 460 can include any type of wired or wireless communication channel capable of coupling together computing nodes. This includes, but is not limited to, a local area network, a wide area network, or a combination of networks. In one embodiment of the present invention, network 460 includes the Internet. In some embodiments of the present invention, network 460 includes phone and cellular phone networks.

Database 470 can include any type of system for storing data in non-volatile storage. This includes, but is not limited to, systems based upon magnetic, optical, or magneto-optical storage devices, as well as storage devices based on flash memory and/or battery-backed up memory. Note that database 470 can be coupled: to a server (such as server 450), to a client, or directly to a network. In some embodiments of the present invention, database 470 is used to store information related to diagnostic information and/or diagnostic formatters. Alternatively, other entities in computing environment 400 may also store such data (e.g., servers 430-450).

Devices 480 can include any type of electronic device that can be coupled to a client, such as client 412. This includes, but is not limited to, cell phones, personal digital assistants (PDAs), smartphones, personal music players (such as MP3 players), gaming systems, digital cameras, portable storage media, or any other device that can be coupled to the client. Note that, in some embodiments of the present invention, devices 480 can be coupled directly to network 460 and can function in the same manner as clients 410-412.

Appliance 490 can include any type of appliance that can be coupled to network 460. This includes, but is not limited to, routers, switches, load balancers, network accelerators, and specialty processors. Appliance 490 may act as a gateway, a proxy, or a translator between server 440 and network 460.

Note that different embodiments of the present invention may use different system configurations, and are not limited to the system configuration illustrated in computing environment 400. In general, any device that supports browser applications and the downloading of signed data sets may incorporate elements of the present invention.

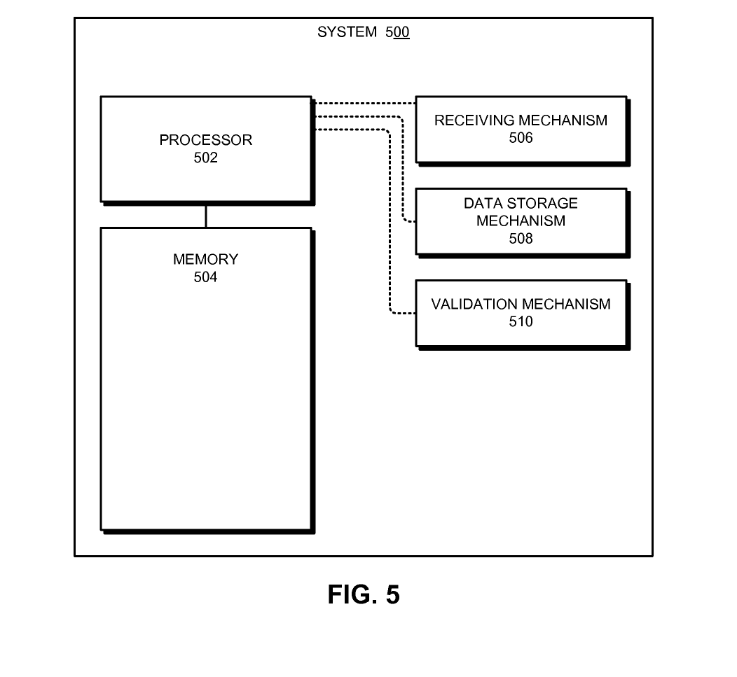

FIG. 5 illustrates a computing device 500 that includes a processor 502 and a memory 504. Computing device 500 also includes a receiving mechanism 506, a data storage mechanism 508 associated with a browser application (not shown), and a validation mechanism 510 associated with the browser application. Computing device 500 uses receiving mechanism 506, data storage mechanism 508, and validation mechanism 510 to ensure the integrity of a downloaded data set.

During operation, computing device 500 uses receiving mechanism 506 to receive a data set that was signed using the private key of a host computer, and data storage mechanism 508 stores this data set. Receiving mechanism 506 also receives a public key associated with the host computer (e.g., when a browser application executing on processor 502 accesses a web page associated with the data set). Validation mechanism 510 ensures the integrity of the data set by executing scripted program code that validates the data set using the public key.

In some embodiments of the present invention, some or all aspects of receiving mechanism 506, data storage mechanism 508, and/or validation mechanism 510 can be implemented as dedicated hardware modules in computing device 500. These hardware modules can include, but are not limited to, processor chips, application-specific integrated circuit (ASIC) chips, field-programmable gate arrays (FPGAs), memory chips, and other programmable-logic devices now known or later developed.

Processor 502 can include one or more specialized circuits for performing the operations of the mechanisms. Alternatively, some or all of the operations of receiving mechanism 506, data storage mechanism 508, and/or validation mechanism 510 may be performed using general-purpose circuits in processor 502 that are configured using processor instructions. Thus, while FIG. 5 illustrates receiving mechanism 506, data storage mechanism 508, and validation mechanism 510 as being external to processor 502, in alternative embodiments some or all of these mechanisms can be internal to processor 502.

In these embodiments, when the external hardware modules are activated, the hardware modules perform the methods and processes included within the hardware modules. For example, in some embodiments of the present invention, the hardware module includes one or more dedicated circuits for performing the described operations. As another example, in some embodiments of the present invention, the hardware module is a general-purpose computational circuit (e.g., a microprocessor or an ASIC), and when the hardware module is activated, the hardware module executes program code (e.g., BIOS, firmware, etc.) that configures the general-purpose circuits to perform the operations described above.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for ensuring the integrity of a data set, the method comprising:
receiving the data set from a host computer, wherein the data set is signed by the host computer using a private key and received by a browser application executing on a receiving computing device;
storing the data set in a data store associated with the browser application;
receiving a public key associated with the private key from the host computer while accessing a web page associated with the data set in the browser application; and
ensuring the integrity of the data set by executing in the browser application scripted program code that validates the data set using the public key.

2. The computer-implemented method of claim 1, wherein validating the data set using the public key ensures that the data set has not been modified while being stored in the data store and reduces browser application delays associated with re-downloading the data set.

3. The computer-implemented method of claim 1, wherein validating the data set using the public key involves:
using the public key to decode a signature for the data set;
calculating a hash value for the data set; and
comparing the hash value with the decoded signature.

4. The computer-implemented method of claim 1,
wherein the method further involves forwarding the data set to a third computing device;
wherein the third computing device validates the data set using the public key; and
wherein transferring the signed data set to the third computing device via the receiving computing device facilitates preserving data integrity for the data set without requiring direct communication between the host computer and the third computing device.

5. The computer-implemented method of claim 1,
wherein the public key is cached for a limited lifespan in the browser application; and
wherein the public key is re-acquired after the limited lifespan has expired by re-accessing the web page associated with the data set from the browser application.

6. The computer-implemented method of claim 1, wherein the data set is signed by the host computer using an asymmetric signing technique.

7. The computer-implemented method of claim 6, wherein a signature for the signed data set is computed based on one or more of the following:
a data block;
an identifier associated with the data block;
size data for the data block;
a nonce;
a timestamp; and
a user identifier.

8. The computer-implemented method of claim 1, wherein the data store provides domain-independent storage capabilities that can be accessed using browser-based scripting languages, language interpreters, and markup languages.

9. A computer-implemented method for ensuring the integrity of a data set, the method comprising:
receiving the data set from a host computer, wherein the data set is signed by the host computer using a private key and received by a browser application executing on a receiving computing device;
storing the data set in a data store associated with the browser application; and
executing in the browser application scripted program code that forwards the data set to a third computing device;
wherein the third computing device validates the data set using a public key associated with the private key from the host computer.

10. The computer-implemented method of claim 9, wherein validating the data set using the public key involves:
using the public key to decode a signature for the data set;
calculating a hash value for the data set; and
comparing the hash value with the decoded signature.

11. The computer-implemented method of claim 9, wherein the data store provides domain-independent storage capabilities that can be accessed using browser-based scripting languages, language interpreters, and markup languages.

12. A non-transitory computer-readable storage medium storing instructions that when executed by a computer cause the computer to perform a method for ensuring the integrity of a data set, the method comprising:
receiving the data set from a host computer, wherein the data set is signed by the host computer using a private key and received by a browser application executing on a receiving computing device;
storing the data set in a data store associated with the browser application;
receiving a public key associated with the private key from the host computer while accessing a web page associated with the data set in the browser application; and
ensuring the integrity of the data set by executing in the browser application scripted program code that validates the data set using the public key.

13. The non-transitory computer-readable storage medium of claim 12, wherein validating the data set using the public key ensures that the data set has not been modified while being stored in the data store and reduces browser application delays associated with re-downloading the data set.

14. The non-transitory computer-readable storage medium of claim 12, wherein validating the data set using the public key involves:
using the public key to decode a signature for the data set;
calculating a hash value for the data set; and
comparing the hash value with the decoded signature.

15. The non-transitory computer-readable storage medium of claim 12,
wherein the method further involves forwarding the data set to a third computing device;
wherein the third computing device validates the data set using the public key; and
wherein transferring the signed data set to the third computing device via the receiving computing device facilitates preserving data integrity for the data set without requiring direct communication between the host computer and the third computing device.

16. The non-transitory computer-readable storage medium of claim 12,
wherein the public key is cached for a limited lifespan in the browser application; and
wherein the public key is re-acquired after the limited lifespan has expired by re-accessing the web page associated with the data set from the browser application.

17. The non-transitory computer-readable storage medium of claim 12, wherein the data set is signed by the host computer using an asymmetric signing technique.

18. The non-transitory computer-readable storage medium of claim 17, wherein a signature for the signed data set is computed based on one or more of the following:
a data block;
an identifier associated with the data block;
size data for the data block;
a nonce;
a timestamp; and
a user identifier.

19. The non-transitory computer-readable storage medium of claim 12, wherein the data store provides domain-independent storage capabilities that can be accessed using browser-based scripting languages, language interpreters, and markup languages.

20. A computing device configured to ensure the integrity of a data set, comprising:
a processor;
a memory;
a receiving mechanism configured to receive the data set from a host computer, wherein the data set is signed by the host computer using a private key and received by a browser application executing on the processor;
a data store associated with the browser application that is configured to store the data set; and
a validation mechanism associated with the browser application;
wherein the receiving mechanism is further configured to receive a public key associated with the private key from the host computer when the browser application accesses a web page associated with the data set; and
wherein the validation mechanism is configured to ensure the integrity of the data set by executing scripted program code that validates the data set using the public key.
